(19) United States
(12) Patent Application Publication
(10) Pub. No.: US 2022/0011165 A1
(43) Pub. Date: Jan. 13, 2022

(54) ELEVATED TEMPERATURE SCREENING USING PATTERN RECOGNITION IN THERMAL IMAGES

(71) Applicant: Adasky, Ltd., Yokneam lllit (IL)

(72) Inventors: Oleg KUYBEDA, Portland, OR (US); Igor IVANOV, Haifa (IL); Yonatan DISHON, Haifa (IL); Yair ALPERN, Kiryat Tivon (IL)

(73) Assignee: Adasky, Ltd., Yokneam Illit (IL)

(21) Appl. No.: 16/922,700

(22) Filed: Jul. 7, 2020

(51) Int. Cl. G01J 5/02; H04N 5/33

(52) U.S. Cl. CPC G01J 5/025; G01J 2005/0077; H04N 5/33

(57) ABSTRACT

A method and system for estimating core temperature of objects are provided. The method includes receiving an external temperature of the at least one object using the radiometric camera; capturing ancillary parameters indicative of at least environmental conditions in an area where a radiometric camera is deployed; identifying at least one object shown in an input image stream; and estimating a core temperature of each of the at least one object based on the external temperature measured for each of the at least one object by the radiometric camera and the ancillary parameters, wherein the estimated core temperature is indicative of an elevated temperature of an object.

### TECHNICAL FIELD

The present disclosure relates generally to computing processes for high-throughput early detection, screening and monitoring of elevated temperature subjects in crowded high-traffic areas.

### BACKGROUND

Infectious diseases, such as influenza (flu) or the 2019 novel strain of coronavirus (COVID-19), are caused by viruses. In 2019, the entire world began experiencing the worst pandemic since the 1918 influenza pandemic. To control this pandemic and avoid future outbreaks, new methods and devices that allow early detection, screening, monitoring and containment of individuals posing a high risk of disease transmission are needed.

Detection of such individuals is especially critical in places with high population densities such as airports, shopping centers, schools, hospitals, and the like. Thus, detection devices which are capable of monitoring high volumes of people in high-traffic areas in real time and with high precision are required.

One of the most common symptoms of infectious diseases is an elevated body temperature. To this end, some existing solutions for measuring human body temperatures in crowded areas are based on thermal cameras. Uncooled Bolometric thermal infrared (IR) cameras capture image wavelengths in the range of approximately seven to fourteen micrometers, also known as the long-wave infrared (LWIR) spectrum band. A typical IR camera uses an infrared sensor to detect infrared energy that is guided to the sensor through the camera's lens.

When implementing thermal measurements to obtain body temperature, the technical challenge is the calibration of the camera to achieve accurate measurements. Existing solutions suggest using calibrations based on external and/or internal components. Such components provide a thermal reference point to the measurement.

One example of an external component is a blackbody. A blackbody at thermal equilibrium (a constant temperature) emits electromagnetic radiation called black-body radiation. The radiation has a spectrum that is determined by the temperature alone. An ideal blackbody in thermal equilibrium has two notable properties: those of an ideal emitter and of a diffuse emitter. To achieve higher accuracy, a number of blackbodies are required. That is, the camera needs to be installed together with the blackbodies on site. This requires adjusting and calibrating the location of the blackbodies with respect to the camera, as well as waiting for all the involved temperature sources to stabilize. As such, implementing these solutions complicates the operation of the camera and increases the cost.

Furthermore, calibration of thermal cameras requires stabilizing a temperature of the thermal image of the sensor, a pixel to temperature calibration, and a rudimentary algorithm for calibrating temperature readings, as a function of distance to the object-of-interest. Even after achieving the required calibration, the temperature readings would be accurate only for temperatures of high-emissivity objects that are significantly larger than pixel size and that have a relatively uniform temperature distribution. That is, the temperature readings would be for non-uniform objects (like human faces), with temperature variations that are smaller than the pixel size.

As such, measurements of body temperatures by external devices (such thermal cameras or other thermal sensors) may not be the same as measurement of the core temperature of a human body (e.g., measured by a thermometer placed under the tongue or rectum). Accurate core temperature readings are important for detecting high-risk individuals that may be carriers of COVID-19 or other contagious diseases.

As such, there is a need to provide a solution that would improve the temperature readings of a radiometric camera to better estimate the core body temperature of live subjects in high-traffic areas.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for estimating core temperature of objects. The method comprises receiving an external temperature of the at least one object using the radiometric camera; capturing ancillary parameters indicative of at least environmental conditions in an area where a radiometric camera is deployed; identifying at least one object shown in an input image stream; and estimating a core temperature of each of the at least one object based on the external temperature measured for each of the at least one object by the radiometric camera and the ancillary parameters, wherein the estimated core temperature is indicative of an elevated temperature of an object.

Certain embodiments disclosed herein also include a system for estimating core temperature of objects, comprising: a processing circuitry; a memory containing instructions that, when executed by the processing circuitry, configure the processing circuitry to: receive an external temperature of the at least one object using the radiometric camera; capture ancillary parameters indicative of at least environmental conditions in an area where a radiometric camera is deployed; identify at least one object shown in an input image stream; and estimate a core temperature of each of the at least one object based on the external temperature measured for each of the at least one object by the radiometric camera and the ancillary parameters, wherein the estimated core temperature is indicative of an elevated temperature of an object. Certain embodiments disclosed herein also include

Certain embodiments disclosed herein also include a system for early detection of infectious diseases, comprising: a radiometric camera configured to measure an external temperature of at least one object; a computer connected to the radiometric camera and configured to estimate a core temperature and an infectious risk score for each of the at least one object; and a display connected to the computer and configured to display a thermal image stream captured by the radiometric camera together with the estimated core temperature and the infectious risk score of the at least one object.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a radiometric system identifying elevated body temperature individuals, according to an embodiment

FIG. 2 is a flow diagram illustrating the process for core temperature estimation of objects according to an embodiment.

FIG. 3 is a flowchart illustrating a method for measuring core temperature and detecting objects with temperature readings measured for multiple objects simultaneously, according to an embodiment.

FIG. 4 is a flowchart illustrating the application of the various embodiments to determine score objects based on their likelihood to have an abnormal body temperature reading according to an embodiment.

FIG. 5 is a block diagram of a high throughput radiometric camera, utilized to describe the various disclosed embodiments.

FIG. 6 is a block diagram of a radiometric computer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments include techniques for detecting individuals with elevated body temperature (which can be potential carriers of infectious diseases), based on radiometric readings from radiometric cameras and a machine learning model configured to estimate core temperatures of living subjects based on the radiometric readings. In an embodiment, the machine learning model estimates the difference between a core temperature and a radiometric reading measured to an observed object (e.g., a person) that is one of the subjects for which temperatures are to be determined. The radiometric camera is designed to provide simultaneous accurate body temperature measurements for multiple objects in a crowded area.

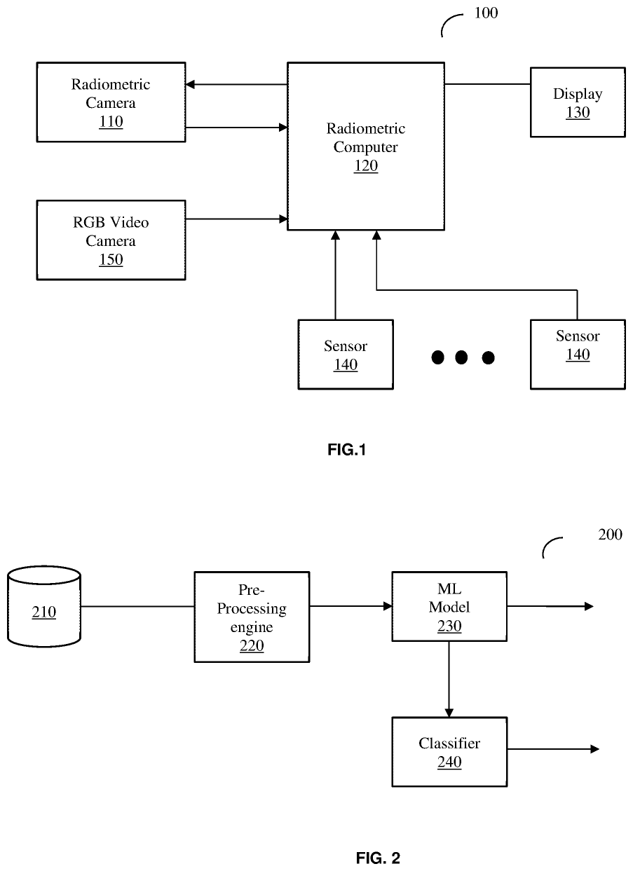

FIG. 1 shows an example block diagram of a radiometric system 100 for identifying carriers of infectious diseases according to an embodiment. The radiometric system 100 includes a radiometric camera 110, a radiometric computer 120, a display 130, and a plurality of sensors 140. The system 100 may also include an RGB video camera 150 (i.e., a video camera providing video with colors captured using the RGB color model).

The radiometric camera 110 outputs a video stream of thermal images (hereinafter a “thermal video stream”). The thermal video stream may be interposed with body temperature measurements and displayed together on a display 130. The display 130 may be an LCD screen encapsulated in the same housing (not shown) of the camera 110. Alternative, the display 130 may be integrated in or externally connected to the radiometric computer 120. The temperature measurements are presented with respect to each object identified in the thermal image. The radiometric camera 110 may be, but is not limited to, a thermal camera.

In an example implementation, the body temperature measurements may be presented using boxes around the object. The measurements may be presented as a numerical value, a color-coded indication, or both. In a further embodiment, an alert may be displayed when a person with a potential infectious disease is detected. The alert would pinpoint an infected person identified in the crowd.

The sensors 140 are connected to the radiometric computer 120 and configured to provide signals on environmental conditions such as, but not limited to, an ambient temperature, a humidity level, an atmospheric pressure, a wind velocity, a location, and so on. Thus, the sensors 140 may include a thermometer, a humidity sensor, a Global Positioning System (GPS), an anemometer, and the like. The sensors 140 may also include an HVAC controller that can provide a current room temperature and humidity level.

In some configurations, the radiometric computer 120 is also connected to an RGB video camera 150 to provide RGB video streams (hereinafter RGB images). The RGB video camera 150 is configured to capture the same scene as the radiometric camera 110.

The radiometric computer 120 is also configured to estimate a temperature difference (Δt) serving as a correction between an external temperature (tₑₓₜ) measured by the radiometric camera 110 and a core temperature (t_{core}) of an object. In an example embodiment, an object is a person shown in the thermal image. The core temperature is a human body temperature, as would be measured by a thermometer placed under the tongue, or rectally.

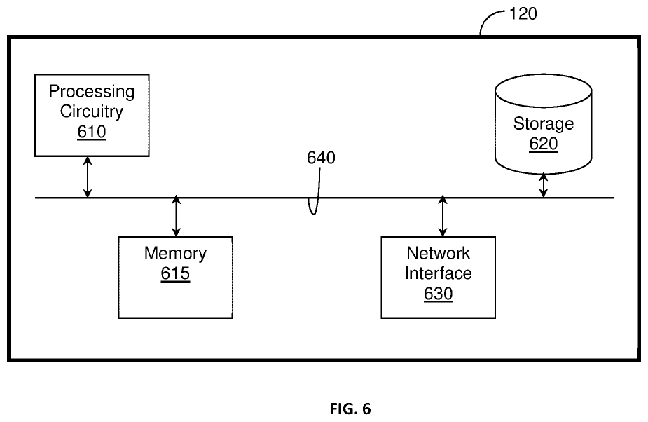

The radiometric computer 120 may be any computing device or unit including a processing circuitry (not shown) coupled to a memory (not shown), an input/output (I/O) interface (not shown), and a network interface (not shown). An example block diagram of the radiometric computer 120 is provided in FIG. 6.

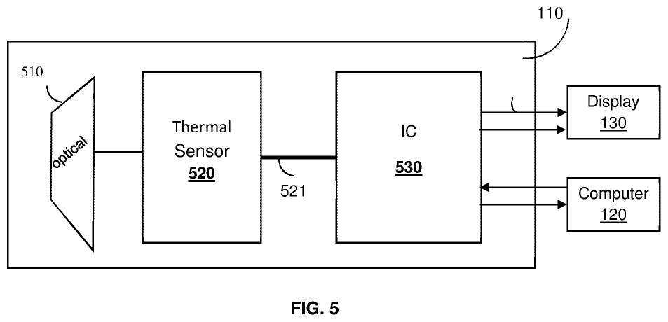

According to the disclosed embodiments, the radiometric computer 120 is configured to perform at least a perception process and a temperature estimation process. The perception process is used to identify objects in input images (e.g., thermal or RGB images). In an embodiment, the identified object is a person and the measured temperature is a human body temperature. The radiometric computer 120 may receive environmental data related to, for example, an ambient temperature, a current measured room (e.g., an office) temperature, humidity information, and the like. To this end, the radiometric computer 120 may interface with HVAC controllers, wireless thermostats, and the like. Such data may be provided to the camera 100 to be utilized in a radiometry process. The radiometry process is a process performed by the radiometric camera 110 to provide accurate radiometric readings. An example radiometric camera 110 that can be utilized according to the disclosed embodiments are further discussed in FIG. 5.

According to the disclosed embodiments, the temperature estimation process is implemented using a machine learning technique, discussed in further detail below. In an example embodiment, the machine learning technique is unsupervised, semi-supervised, or both.

The radiometric system 100 illustrated in FIG. 1 is a screening and monitoring system for detecting objects with elevated body temperature (i.e., potential carriers of infectious diseases, such as influenza, coronavirus, severe acute respiratory syndrome, and the like). Thus, by providing a system that can accurately measure the body temperature, the disclosed embodiments allow for providing early detection, screening and monitoring of abnormally high body temperatures and thus for detecting potential carriers infectious diseases. Furthermore, due to the ability of the radiometric system 100 to measure temperatures of many individuals simultaneously, the system can be installed in areas with high traffic of people, such as airports, stadiums, train stations, and the like.

FIG. 2 is an example flow diagram 200 illustrating the process for the core temperature estimation of live objects according to an embodiment.

In an example embodiment, the temperature estimation is performed by a machine learning model, where the training data includes an input dataset 210 without any corresponding target output values. In this embodiment, the input dataset 210 may include facial images of objects captured by the radiometric camera 110, FIG. 1. In an embodiment, the input dataset 210 also includes the signals indicative of environmental conditions captured by the sensors 140 and facial images of objects captured by the RGB video camera 150.

The input dataset is processed by the data pre-processing engine 220 in order to extract and select features. In some examples, the pre-processing engine 220 may also include normalizing the input dataset 210. The normalizing may include removing noises from images, scaling temperature on the same temperature scale, and the like.

The features may include the temperature extracted from each facial thermal image, i.e., the temperature as measured by the radiometric camera and ancillary parameters captured by external sensors. The ancillary parameters may include, but are not limited to, an ambient temperature, a humidity level, a wind force, a facial pixel value pattern of an object in a thermal or RGB image, the distance between the RGB video camera and an identified object, an atmospheric pressure, sun direction, and the like.

The features are fed into a machine learning model 230 that is trained to deduce the core temperature correction difference Δt from the input features. In an example embodiment, the model 230 is an unsupervised or semi-supervised machine learning model. The training of the model 230 is performed during a learning period, where training input thermal images-based features are assumed to be of objects (people) that are in good health, thereby defining the feature distribution reference model describing the healthy, normal and low-risk objects under given environmental conditions determined by the ancillary parameters. That is, the core temperature values of healthy objects are all assumed to have a certain distribution with values below 38° C. The machine learning model 230 is trained to approximate this distribution using at least a predefined number of thermal and environmental inputs. For example, the number of training inputs may be 10,000 images.

In an operation mode (detection), the model 230 outputs the Δt which is an estimated difference between an external temperature (tₑₓₜ), measured by the radiometric camera 110 and a core temperature t_{core} of an object for given environment conditions, measured using ancillary sensors.

In another embodiment, the model 230 is further configured to classify objects with respect to their risk (e.g., low-risk, mid-risk or high-risk) of having an elevated body temperature and, therefore, of being carriers of infectious diseases. In an embodiment, such risk is realized by an “infectious risk score” indicating the likelihood of an object to have an elevated body temperature. The score may be, for example, a numerical value between 0-100.

The classifier 240, in embodiment, is configured to classify objects based on anomaly image patterns and ancillary parameters by applying the statistical models to detect the abnormalities directly. In an embodiment, the features include at least the facial pattern in thermal images, RGB images, or both. The features may also include any of the ancillary parameters and the estimated core temperature. It should be appreciated that determining the risk score does not require an accurate core temperature t_{core}, as the model classifier 240 is trained to identify abnormal fever-related patterns, in part, based on the captured thermal images, RGB images, or both.

According to an embodiment, the unsupervised machine learning classifier 240 may be implemented using a deep neural network. Other techniques may include K-means, X-means, regression tree, support vector machines, decision trees, random forests, or other similar statistical techniques.

In an embodiment, the classifier 240 is provided the elevated body temperature score from the machine learning model 230. The classifier 240 is also a trained unsupervised machine learning model. The features input to the classifier 240 are the core temperature t_{core} (which is the sum of tₑₓₜ and Δt) and the RGB images.

In some embodiments, the machine learning model 230 and the classifier 240 are realized using the same neural network. That is, such a neural network may be configured to perform the two tasks of estimating the temperature difference and classifying objects. In this configuration, the output layers may be different, while the input and internal layers may be the same.

In some embodiments, the difference temperatures may be estimated using a semi-supervised model. This allows it to move into a detection mode as the training may be based on small sets of labeled data. The labeled data can be collected from an archive of previously diagnosed objects.

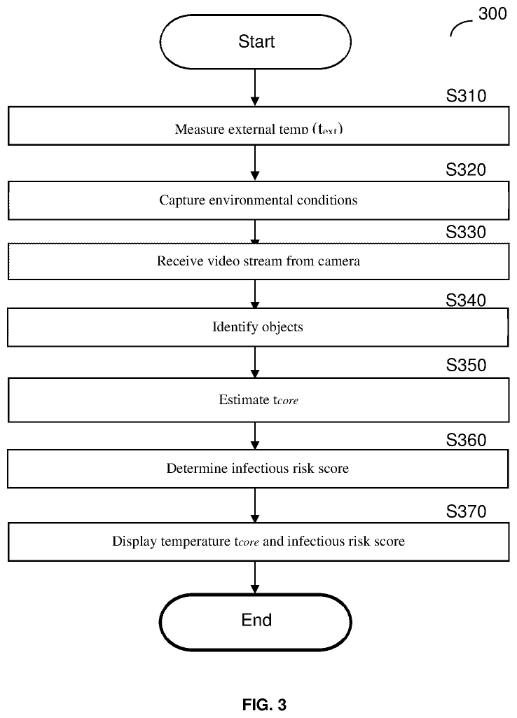

FIG. 3 shows an example flowchart 300 illustrating a method for measuring core temperature and determining infectious risk scores for multiple objects simultaneously, according to an embodiment. As noted above, an object may be a person.

At S310, an external temperature of each object is measured by a radiometric camera, where the objects are shown in a thermal image captured by the radiometric camera. In an example embodiment, S310 includes estimating a gamma drift coefficient based on an input thermal image; performing, based on the gamma drift coefficient and the input thermal image, a sensor temperature stabilization to provide an ambient-stabilized thermal image, where the ambient-stabilized thermal image is invariant to temperature changes of the infrared sensor; performing ambient calibration to estimate a scene temperature based on the ambient-stabilized thermal image; and measuring, based on the estimated scene temperature and a calibrated attenuation factor, a temperature of each of at least one object shown in the input thermal image, where the temperature of each of the at least one object is measured independently of the ambient temperature of the radiometric camera. The infrared sensor is part of the radiometric camera.

At S320, ancillary parameters indicative of at least environmental conditions are captured by one or more sensors (e.g., the sensors 140, FIG. 1). In an embodiment, the ancillary parameters include, but are not limited to, an ambient temperature, a humidity level, an atmospheric pressure, a wind velocity, a location, and so on.

At S330, a stream of thermal images, RGB images, or both, is received. The thermal images may be provided by the radiometric camera, while the RGB images are received from a video camera (e.g., the RGB video camera 150, FIG. 1). The video camera captures the same scene as the radiometric camera. The thermal images, RGB images, or both, will be referred to hereinafter as an “image stream”.

At S340, objects are identified in a thermal image provided by the radiometric camera. S340 may include removing any fixed pattern noises for the thermal image. In an embodiment, S340 includes performing a perception process.

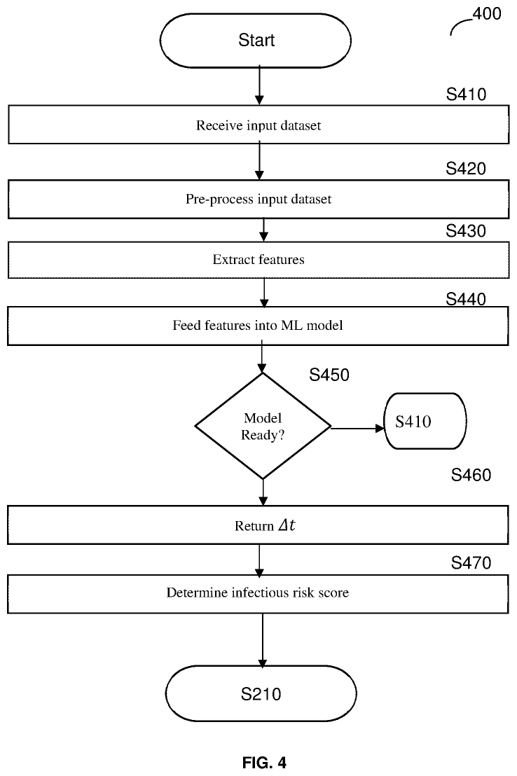

At S350, a core temperature of each object is estimated using, for example, an unsupervised machine learning model. The estimation is based on the temperature difference between the temperature measured by the radiometric camera (tₑₓₜ), and the estimated Δt, which serves as a correction factor that provides a best-guess for the difference between the external temperature tₑₓₜ and the core temperature t_{core}. The process of S350 is discussed in more detail with respect to FIG. 4. The core temperature provides an indication for an elevated body temperature for each identified object.

At S360, an infectious risk score is determined by analyzing each identified object. The infectious risk score is indicative as to whether an object can be a potential carrier of an infectious disease. The score is determined by the machine learning model as discussed in more detail with respect to FIG. 4 in response to the elevated body temperature screenings.

At S370, the estimated core temperature together with infectious risk score may be displayed next to each object identified in the scene.

FIG. 4 shows an example flowchart 400 illustrating the application of the machine learning model utilized for estimating a core temperature and an infectious risk score according to an embodiment.

At S410, an input dataset is received. The input dataset includes at least the image stream. The input dataset may further include ancillary parameters, such as those mentioned above.

At optional S420, the input dataset is pre-processed. In an embodiment, S420 includes reducing noises (e.g., fixed pattern noises) in the images included in the image stream and scaling all temperatures of the ancillary parameters to the same metrological scale.

At S430, features are extracted from the preprocessed input dataset. The features may include at least a facial temperature of each object, values of the environmental conditions, or both. In an embodiment, S430 further includes extracting facial patterns from an image stream, the distance between an object to a camera (either the radiometric camera or video camera), or both.

At S440, the features are fed into a machine learning model configured to statistically estimate the temperature difference Δt between a core temperature of an object and a temperature of an object measured by the radiometric camera. The temperature of an object measured by the radiometric camera is derived from the same thermal images utilized by using the machine learning models as well.

At S450, it is checked if enough data was fed into the machine learning model; if so, at S460, the value (Δt) is returned to be used for estimating the core temperature and detecting elevated body temperature. Otherwise, execution returns to S410 to continue training the machine learning model.

At S470, an infectious risk score of an object may be determined. The infectious risk score indicates a high risk for each object detected with an elevated temperature. The classification at S470 may be based on the core temperature and anomaly patterns recognized in images contained in the image stream. Anomaly patterns may be detected using the statistical distribution models fitted to previously analyzed images, as well as other features extracted from the ancillary parameters.

The determination of the risk score may be performed using an unsupervised or semi-supervised machine learning model. The latter may be trained with a small labeled subset of the image stream, where the measured core temperature of each object shown in the training images is provided. In an embodiment, a confidence score is output with any classification.

FIG. 5 shows an example block diagram of a high-throughput radiometric camera (hereinafter, the “camera 110”) designed according to the various disclosed embodiments. The camera 110 includes an optical unit 510 and a thermal sensor 520 coupled to an integrated circuit (IC) 530. The output of the camera 110 is a video stream of thermal images (hereinafter a “thermal video stream”) captured by the infrared sensor 520 and processed by the IC 530.

In an embodiment, the thermal sensor 520 is an uncooled long-wavelength infrared (LWIR) sensor operating in a spectrum band of wavelengths of 7-14 μm. The spectrum of passive heat emission by a human body, as predicted by Planck's law at 305 K, greatly overlaps with the LWIR spectrum band. Thus, high-resolution LWIR cameras and sensors are a good choice for designing high-throughput temperature screening solutions for human subjects. An uncooled sensor having a small form factor can typically be mass-produced using low-cost technology. The infrared sensor 520 includes, or is realized as, a focal plane array (FPA). A FPA produces a reference signal utilized to derive temperature information from the thermal image signal. In some configurations, the infrared sensor 520 and the FPA (not separately depicted in FIG. 5) are the same unit and are collectively referred to hereinafter as the “infrared sensor 520.”

The camera 110 outputs a thermal image stream (not shown) of denoised thermal images, fed into the radiometric computer 120 and a display 130 (both shown in FIG. 1). The IC 530 is configured to estimate the gamma drift offset and to subsequently neutralize the effect of changes in the sensor's 520 FPA temperature based on this drift so that normalized readings for different temperatures of the FPA can be recorded. The FPA temperature is the temperature in the vicinity of the FPA and infrared sensor 520. The FPA temperature stabilization process results in a pixel response signal (Is). The IC 530 is further configured to determine the scene temperature value (Ts). The Ts value is used, in part, by a radiometric process that is also performed by the IC 530, to determine the temperature of objects in the scene (current denoised image).

In one configuration, the optical unit 510 includes one or more lens elements (not shown), each of which having a predetermined field of view (FoV). In an embodiment, the lens elements may be made of chalcogenide.

In an example configuration, the infrared sensor 520 is coupled through a communication bus (not shown) to the IC 530 to input the captured thermal images, metadata, and other control signals (e.g., clock, synchronization, and the like).

The IC 530 includes a memory, a processing circuitry, and various circuits and modules allowing the execution of the tasks noted herein (not shown). The IC 530 may be realized as a chipset, a SoC, a FPGA, a PLD, an ASIC, or any other type of digital and/or analog hardware components.

According to the disclosed embodiments, the temperature measurements are performed without any external blackbody and without using a shutter as a reference point. Rather, temperature measurements may be based, in part, on a gamma-based drift measurement algorithm that outputs the amount of drift during the camera's 110 operation. The changes in the infrared sensor's 520 temperature creates offsets that may be different from pixel to pixel. Therefore, in addition to a common (DC) drift component, there is a fixed pattern noise that is added to each image. In an embodiment, the IC 530 is configured to measure the fixed-noise pattern during the camera's 110 calibration and estimate the amount of the gamma drift during operation.

The camera 110 is calibrated during manufacturing (e.g., at a lab) prior to operation. The calibration process is performed to stabilize the radiometric camera 110 at a predefined temperature. The calibration process includes reading the ambient temperature, which is periodically read from the infrared sensor 520 to determine temperature stability.

In an example configuration, the infrared sensor 520 and IC 530 are encapsulated in a thermal core (not shown). The thermal core is utilized to ensure a uniform temperature for the camera 110. The temperature calibration of the thermal core is also factory calibration. The optical unit 510 is typically assembled in the camera 110 after the infrared sensor 520 and IC 530 are encapsulated in the thermal core.

The processing performed by the IC 530 enhances the quality of the captured thermal images to allow for the accurate and fast detection of objects (e.g., persons). To this end, the IC 530 may be configured to perform one or more image processing tasks, such as shutterless correction of the captured thermal images, and correction of fixed pattern noise due to ambient drift. In an embodiment, the camera 500 may not include a shutter (or any moving part that can be viewed as shutter). To this end, the camera 130 may be configured to execute shutterless image correction for the performance of a flat-field correction without a shutter. That is, shutterless correction allows for a radiometry image with unwanted fixed pattern noise removed therefrom. In another embodiment, the camera 500 includes a shutter.

In yet another embodiment, the camera 110 includes a shutter (or any equivalent moving part). Using a shutter can allow for improved noise reduction that may be required in static cameras, as well as increasing uniformity in the image-based temperature sensing. Example calibration and the temperature measurement by the camera 110 are further disclosed in U.S. patent application Ser. No. 16/865,124, assigned to the common assigned, which is hereby incorporated by reference.

FIG. 6 shows an example block diagram of the radiometric computer 120 implemented according to an embodiment. The radiometric computer 120 includes a processing circuitry 610 coupled to a memory 615, a storage 620, and a network interface 630. In an embodiment, the components of the radiometric computer 120 may be communicatively connected via a bus 640.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, graphics processing units (GPUs), tensor processing units (TPUs), general-purpose microprocessors, microcontrollers, and digital signal processors (DSPs), and the like, or any other hardware logic components that can perform calculations or other manipulations of information.

The memory 615 may be volatile (e.g., RAM, etc.), non-volatile (e.g., ROM, flash memory, etc.), or a combination thereof. In one configuration, computer readable instructions to implement one or more embodiments disclosed herein may be stored in the storage 620.

In another embodiment, the memory 615 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 610 to perform the various processes described herein.

The storage 620 may be magnetic storage, optical storage, and the like, and may be realized, for example, as flash memory or another memory technology, CD-ROM, Digital Versatile Disks (DVDs), or any other medium which can be used to store the desired information.

The network interface 630 allows the radiometric computer 120 to communicate with peripherals, such as the camera 110, the display, the sensors 140 (FIG. 1), the RGB camera 110, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for estimating core temperature of objects, comprising:
receiving an external temperature of the at least one object using the radiometric camera;
capturing ancillary parameters indicative of at least environmental conditions in an area where a radiometric camera is deployed;
identifying at least one object shown in an input image stream; and
estimating a core temperature of each of the at least one object based on the external temperature measured for each of the at least one object by the radiometric camera and the ancillary parameters, wherein the estimated core temperature is indicative of an elevated temperature of an object.

2. The method of claim 1, wherein estimating the core temperature of each object further comprises:
estimating a temperature difference between the external temperature of an object and the core temperature of the object.

3. The method of claim 1, wherein estimating the temperature difference further comprises:
applying a first machine learning model, wherein the first machine learning model is configured to provide a statistical computed correction factor, wherein the statistical computed correction factor is the temperature difference.

4. The method of claim 4, further comprising:
extracting features from the image stream and the ancillary parameters, wherein the input image stream includes at least one of: a set of thermal images captured by the radiometric camera and a set of RGB images captured by a video camera; and
feeding the extracted features to the machine learning model.

5. The method of claim 4, wherein the extracted features include at least one of: a facial temperature of each object, a facial pattern of each object, a value of an environmental condition, a distance between an object and the radiometric camera, and a distance between an object and a video camera.

6. The method of claim 1, wherein the ancillary parameters are collected by a plurality of sensors.

7. The method of claim 3, further comprising:
determining an infectious risk score for each object with a measured elevated body temperature, wherein the infectious risk score of each object is determined based on the estimated core temperature of each object.

8. The method of claim 7, further comprising:
applying a second machine learning model, wherein the second machine learning model is configured to detect anomaly patterns in the input image stream and the ancillary parameters.

9. The method of claim 8, wherein the first machine learning model and the second machine learning model are the same machine learning model, wherein the first machine learning model is an unsupervised machine learning model.

10. The method of claim 1, further comprising:
simultaneously measuring the external temperature of each of the at least one object via the radiometric camera.

11. The method of claim 1, wherein the radiometric camera is integrated in a system for early detection of infectious diseases.

12. A non-transitory computer readable medium having stored thereon instructions for causing a processing circuitry to perform the method of claim 1.

13. A system for estimating core temperature of objects, comprising: a processing circuitry;
a memory containing instructions that, when executed by the processing circuitry, configure the processing circuitry to:
receive an external temperature of the at least one object using the radiometric camera;
capture ancillary parameters indicative of at least environmental conditions in an area where a radiometric camera is deployed;
identify at least one object shown in an input image stream; and
estimate a core temperature of each of the at least one object based on the external temperature measured for each of the at least one object by the radiometric camera and the ancillary parameters, wherein the estimated core temperature is indicative of an elevated temperature of an object.

14. The system of claim 13, wherein the system is further configured to:
estimating a temperature difference between the external temperature an object and the core temperature of the object.

15. The system of claim 14, wherein the system is further configured to:
applying a first machine learning model, wherein the first machine learning model is configured to provide a statistical computed correction factor, wherein the statistical computed correction factor is the temperature difference.

16. The system of claim 14, wherein the system is further configured to:
extracting features from the image stream and the ancillary parameters, wherein the input image stream includes at least one of: a set of thermal images captured by the radiometric camera and a set of RGB images captured by a video camera; and
feeding the extracted features to the machine learning model.

17. The system of claim 16, wherein the extracted features include at least one of: a facial temperature of each object, a facial pattern of each object, a value of an environmental condition, a distance between an object and the radiometric camera, and a distance between an object and a video camera.

18. The system of claim 13, wherein the ancillary parameters are collected by a plurality of sensors.

19. The system of claim 13, further comprising:
determining an infectious risk score for each object with a measured elevated body temperature, wherein the infectious risk score of each object is determined based on the estimated core temperature of each object.

20. The system of claim 19, further comprising:
applying a second machine learning model, wherein the second machine learning model is configured to detect anomaly patterns in the input image stream and the ancillary parameters.

21. The system of claim 20, wherein the first machine learning model and the second machine learning model are the same machine learning model, wherein the first machine learning model is an unsupervised machine learning model.

22. The system of claim 13, further comprising:
simultaneously measuring the external temperature of each of the at least one object via the radiometric camera.

23. The system of claim 13, wherein the radiometric camera is integrated in a system for early detection of infectious diseases.

24. A system for early detection of infectious diseases, comprising:
a radiometric camera configured to measure an external temperature of at least one object;
a computer connected to the radiometric camera and configured to estimate a core temperature and an infectious risk score for each of the at least one object; and
a display connected to the computer and configured to display a thermal image stream captured by the radiometric camera together with the estimated core temperature and the infectious risk score of the at least one object.

25. The system of claim 24, further comprises:
a video camera to provide a RGB image stream; and
a plurality of sensors for measuring environmental conditions.

26. The system of claim 25, wherein the computer is further configured to:
receive an external temperature of the at least one object using the radiometric camera;
capture ancillary parameters indicative of at least the environmental conditions in an area the a radiometric camera is deployed;
identify at least one object shown in an input image stream comprising the thermal image stream and the RGB image stream; and
estimate a core temperature of each of the at least one object based on the external temperature measured for each of the at least one object by the radiometric camera and the ancillary parameters, wherein the estimated core temperature is indicative of an elevated temperature of an object.

27. The system of claim 26, wherein the system is further configured to:
estimate a temperature difference between the external temperature of an object and the core temperature of the object.
